(19) United States
(12) Patent Application Publication
(10) Pub. No.: US 2001/0026310 A1
(43) Pub. Date: Oct. 4, 2001

(54) LED beam source and scanning exposure apparatus

(75) Inventor: Tsutomu Kimura, Saitama (JP)

Correspondence Address: YOUNG & THOMPSON, 745 SOUTH 23RD STREET 2ND FLOOR, ARLINGTON, VA, 22202

(73) Assignee: Fuji Photo Optical Co., Ltd.

(21) Appl. No.: 09/811,396

(22) Filed: Mar. 20, 2001

(30) Foreign Application Priority Data
Mar. 29, 2000 (JP) 2000-091585

(51) Int. Cl. B41J 2/45; B41J 2/435

(52) U.S. Cl. 347/238; 347/232; 347/241; 347/243

(57) ABSTRACT

An LED beam source emits plural light beams which are independently controllable and become incident light of a polygon mirror. The LED beam source comprises LED elements of which light-emitting timing and light intensity are independently controllable, a base member for retaining the LED elements, and a mask plate for commonly covering light emitting sides of the LED elements. The mask plate is formed with beam openings corresponding to the respective outputted beams. Four corners of the mask plate are provided with positioning holes, and four corners of the base member are provided with positioning projections. Assembling is easily performed by inserting the positioning projection into the positioning hole.

### BACKGROUND OF THE INVENTION

1. Field of the Invention

The present invention relates to an LED beam source and a scanning exposure apparatus using a plurality of LED elements which are independently controllable.

2. Description of the Related Art

Such as disclosed in a large number of documents, for example U.S. Pat. No. 4,800,400 (U.S. counterpart of Japanese Patent 2,813,353) and U.S. Pat. No. 4,809,020, LED elements of red, blue and green being independently controllable are used as light sources of a small-sized printer. In such a printer, scanning exposure is performed relative to an instant photo film in a flying-spot method based on electronic image data.

A light emitting face of the LED element is individually covered with a mask provided with an opening. A beam having passed through the opening becomes incident light of a scanning mirror to expose the instant photo film. The LED elements respectively covered with the mask are arranged at certain intervals so as to be level relative to a scanning direction.

However, it is not easy to align both of the LED elements and the openings with accuracy. Because, the LED elements of red, blue and green are positioned after the LED elements have been individually covered with the mask provided with the opening.

Actually, when resolution of 300 dpi is required for the printing quality, the resolution is ten or more per 1 mm. It is necessary to scan an exposure surface of the film with a scanning beam spot of 100 μm or less. In case an error of 10% is allowed for the scanning beam spot of 100 μm and in case an optical system between the opening for the LED element and the exposure surface has a magnification of an actual size, the individual mask for the LED beam is required to be positioned under the following conditions, for example. If the following conditions are not satisfied, the printing quality is likely to be damaged due to loss of color definition occurring on the exposure surface. Besides this, the printing quality is damaged due to a decline of the resolution, striations occurring along a scanning line, and so forth.

(1) Positional difference in a perpendicular direction to the scanning direction is within plus or minus 5 μm.

(2) The remainder of dividing the opening interval by an opening length is within plus or minus 5 μm.

(3) Dispersion regarding sizes of three openings is within plus or minus 5 μm.

(4) Dispersion regarding inclination of three openings relative to the scanning direction is within plus or minus 3 degrees.

Incorporating the above-mentioned LED beam source accompanies complexity. Thus, there arise problems in that assembling efficiency is lowered, in that a yield rate is lowered, and in that the manufacturing cost increases.

### SUMMARY OF THE INVENTION

In view of the foregoing, it is a primary object of the present invention to provide an LED beam source and a scanning exposure apparatus which are capable of being incorporated at low cost without deteriorating printing quality.

It is a second object of the present invention to provide an LED beam source and a scanning exposure apparatus which are capable of being incorporated with accuracy.

In order to achieve the above and other objects, the LED beam source and the scanning exposure apparatus according to the present invention comprise a plurality of LED elements and a mask member. As to the LED element, light emitting timing and light intensity thereof are independently controllable. The mask member is disposed so as to commonly cover the light emitting sides of the LED elements. Moreover, the mask member is formed with openings respectively corresponding to outputted beams.

The opening of the mask member has a shape which is similar to that of a beam spot on an exposure surface. Further, the opening has a size which is determined such that a size of the beam spot is divided by a magnification of an optical system disposed between the opening and the exposure surface. Relative distance of the respective openings is about natural-number times of the size of the opening.

Meanwhile, the opening of the mask member is positioned so as not to overlap with an electrode pad provided on a light emitting face of the LED element. The electrode pad is used for wiring.

The LED elements are fixed to a common base member and are constituted of three kinds of LED chips corresponding to three primary colors of the light. The mask member is fixed to the base member so as to position the three openings at light emitting regions of the LED chips. The base member and the mask member include positioning members for retaining each other. The positioning members mechanically set a positional relationship between the light emitting face of the LED element and the opening of the mask member.

According to the LED beam source and the scanning exposure apparatus of the present invention, it is possible to easily and accurately position the beam spot having a precise shape and a precise size in comparison with a case in that positioning is performed on a base member after forming a mask of an individual LED element. Thus, a print having high quality is obtained. At the same time, dispersion of light-source quality is held down to improve the yield rate so that equipment and working time necessary for manufacturing are saved. Hence, the manufacture cost of the beam source may be reduced.

### BRIEF DESCRIPTION OF THE DRAWINGS

The above objects and advantages of the present invention will become apparent from the following detailed description of the preferred embodiments of the invention when read in conjunction with the accompanying drawings, in which:

FIG. 1 is a schematic illustration partially showing a structure of a scanning exposure apparatus according to the present invention;

FIG. 2 is an explanatory illustration showing film feed and development of an instant film;

FIG. 3 is a schematic illustration partially showing an LED beam source according to the present invention;

FIG. 4 is a schematic illustration partially showing the LED beam source;

FIGS. 5A and 5B are explanatory illustrations showing a spot shape of the LED beam source;

FIG. 6 is an explanatory illustration showing an operation of the LED beam sources of red, blue and green;

FIG. 7 is a schematic illustration partially showing a second embodiment of the LED beam source;

FIG. 8 is a schematic illustration partially showing a third embodiment of the LED beam source;

FIG. 9 is a schematic illustration partially showing a fourth embodiment of the LED beam source; and

FIG. 10 is a sectional view of an electronic still camera having a printer in which the present invention is built.

### DETAILED DESCRIPTION OF THE PREFERRED EMBODIMENT(S)

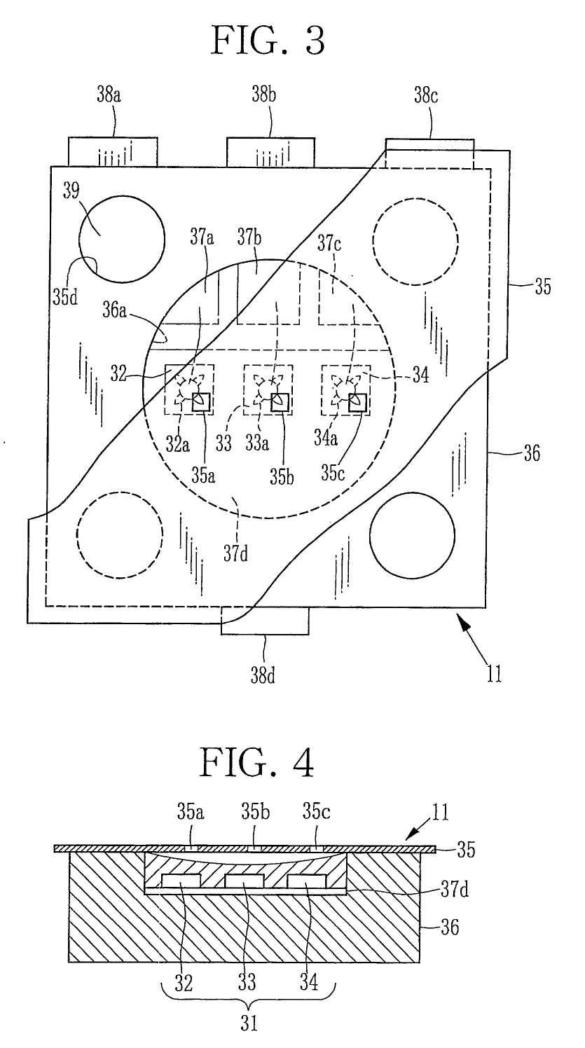

A scanning exposure apparatus of this embodiment is constituted of, such as shown in FIGS. 3 and 4, an LED beam source 11, a mirror 12, a collimator lens 13, a polygon mirror 14, a motor 15, an f·θ lens 16, an instant film unit 17, an exposure mirror 19, and a spreading roller 18. The LED beam source 11 emits beams of red, blue and green. The mirror 12 reflects the beam emitted from the LED beam source 11. The collimator lens 13 converts its incident light into parallel light. The polygon mirror 14 has six reflecting faces and is rotated in a scanning direction. The motor 15 rotates the polygon mirror 14 at a constant speed. The f·θ lens 16 has a size of an orifice corresponding to a scanning area of the polygon mirror 14 and makes the light reflected from the polygon mirror 14 converge. Further, the f·θ lens 16 equalizes a scanning length. The instant film unit 17 is exposed by a beam spot from the LED beam source 11. The exposure mirror 19 reflects the beam, which is from the f·θ lens 16, toward the instant film unit 17. The spreading roller 18 moves the instant film unit 17 in a sub-scanning direction and develops a developer 17b on an exposure surface 17a of the instant film unit 17.

The instant film units 17 are contained in a cassette ten by ten. The instant film unit 17 is drawn out of the cassette one by one to write a scanning line on the exposure surface 17a thereof. After exposure, the developer 17b is processed by the spreading roller 18 to develop and fix an exposure image. Incidentally, the spreading roller 18 is also used to advance the instant film unit 17 by a pitch of the scanning line.

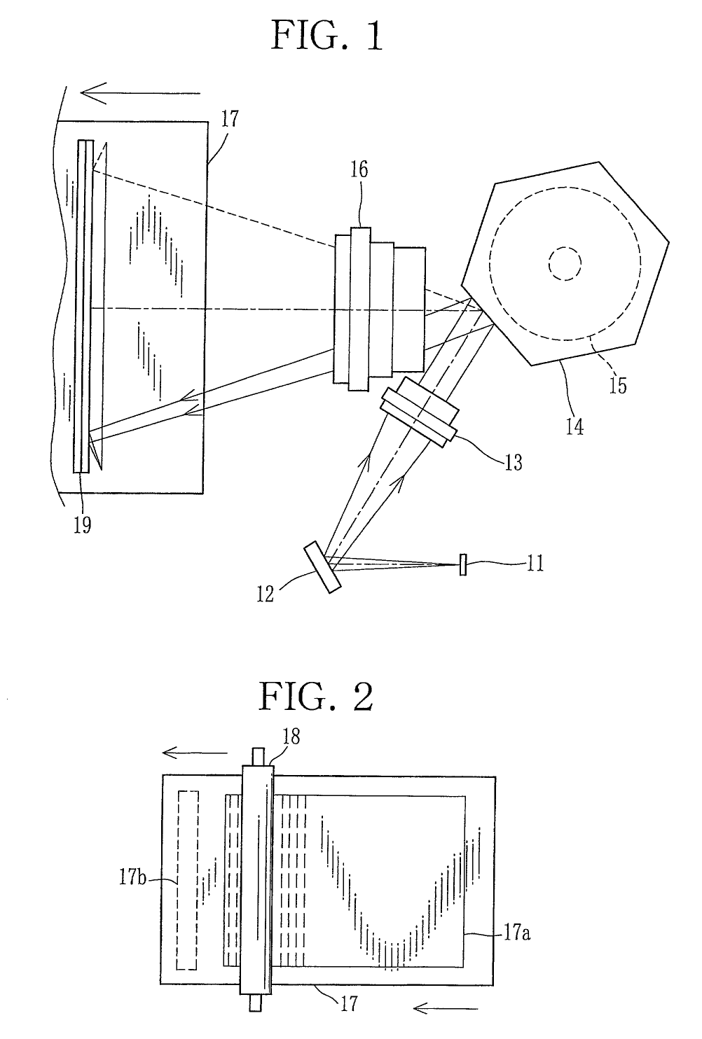

As shown in FIGS. 1 and 2, the LED beam source 11 is constituted of a base member 36, an LED-element group 31 and a mask plate 35. The base member 36 is made of ceramic having a square shape of 5 mm. The LED-element group 31 is disposed on the base member 36 and comprises three LED elements 32, 33 and 34. The mask plate 35 coves the LED-element group 31 together with the base member 36. Moreover, the mask plate 35 is formed with three beam openings 35a, 35b and 35c.

The LED-element group 31 is constituted of three kinds of the LED elements 32, 33 and 34 respectively emitting the light of red, blue and green. Each of the LED elements 32, 33 and 34 is provided with two kinds of pads. As to the LED element 32, one of the pads is an electrode pad 32a made of a thin metal film and is located at a central portion of an upper face of the LED element 32. Similarly, the LED elements 33 and 34 are provided with electrode pads 33a and 34a respectively. The pads 33a and 34a are made of the thin metal film and are respectively located at central portions of upper faces of the LED elements 33 and 34. Meanwhile, the other of the pads is an electrode pad (not shown) located at a central lower face of each of the LED elements 32, 33 and 34. Each luminous level of the LED elements 32, 33 and 34 is determined in accordance with a value of a current flowing between the electrode pads of the respective LED elements 32, 33 and 34.

The mask plate 35 is made of a stainless plate having a width of 10 μm. A central portion of the mask plate 35 is formed with the beam openings 35a, 35b and 35c, and four corners thereof are formed with positioning holes 35d. The beam openings 35a, 35b, 35c and the positioning hole 35d are formed in a photo etching process so that errors concerning a size, a position and a relative distance are regulated within plus or minus 3 μm.

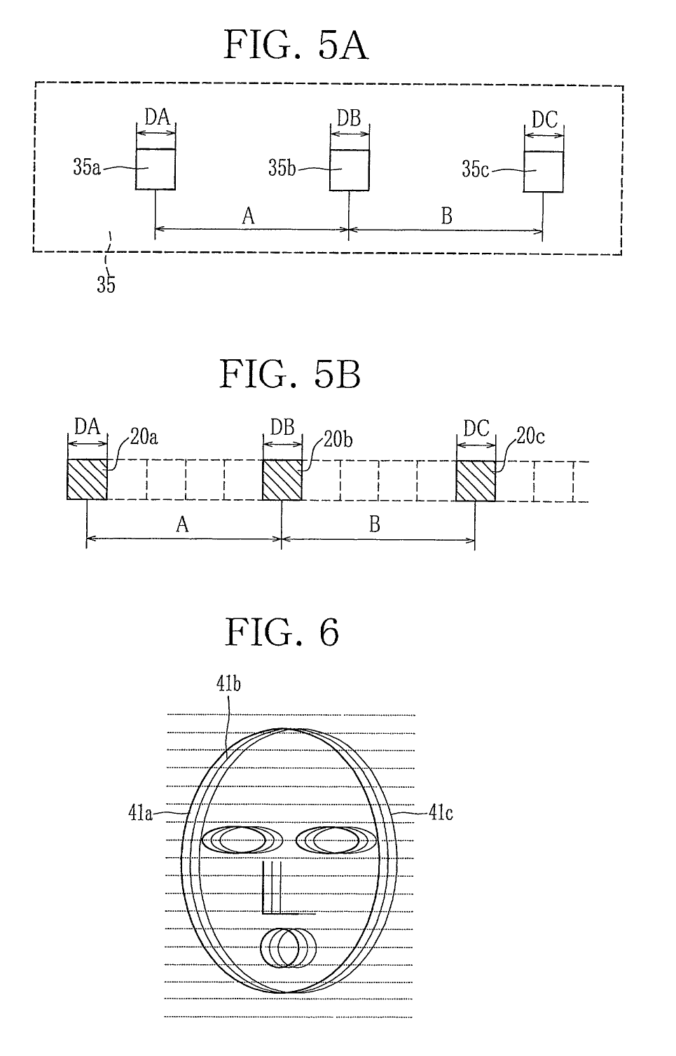

As shown in FIG. 5A, the beam openings 35a, 35b and 35c have a similar square shape, a side of which is equal to 100 μm. In other words, lengths DA, DB and DC shown in FIG. 5A are 100 μm. The beam openings 35a, 35b and 35c are positioned above the three kinds of the LED elements 32, 33 and 34. The beams corresponding to the respective LED elements pass through the beam openings 35a, 35b and 35c toward the outside. In the present embodiment, an interval A between the beam openings 35a and 35b is five times the length of one side of the beam openings 35a, 35b and 35c. Similarly, an interval B between the beam openings 35b and 35c is also five times the length of one side of the beam openings. Accordingly, the intervals A and B are set so as to be equal to 5DA, namely to 500 μm.

The positioning hole 35d formed at the corner of the mask plate 35 is a circular hole having a diameter of 500 μm. The positioning hole 35d is for positioning the mask plate 35.

An upper face of the base member 36 is provided with an LED-element containing portion 36a having a concave shape to retain the LED elements 32, 33 and 34. In order to electrically connect the LED elements 32, 33 and 34 to an external circuit, the bottom of the containing portion 36a is provided with four pads 37a, 37b, 37c and 37d. Further, side faces of the base member 36 are provided with external terminals 38a, 38b, 38c and 38d. Furthermore, four corners of the upper face of the base member 36 are provided with protrusions 39 for positioning the mask plate 35.

The pads 37a, 37b and 37c are minus electrode pads for transmitting a control signal to the respective LED elements 32, 33 and 34. The pad 37d is a plus electrode pad commonly used for the LED elements 32, 33 and 34.

The external terminals 38a, 38b, 38c and 38d are electrically connected to the minus electrode pads 37a, 37b, 37c and the plus electrode pad 37d which are provided on the base member 36. The external terminal 38a is connected to the minus electrode pad 37a. The external terminal 38b is connected to the minus electrode pad 37b. The external terminal 38c is connected to the minus electrode pad 37c. And the external terminal 38d is connected to the plus electrode pad 37d. The external terminals 38a, 38b, 38c and 38d are wired to the external circuit.

The positioning protrusions 39 provided at the four corners of the base member 36 have a cylindrical shape of which a diameter is 500 μm. This protrusion 39 is capable of being inserted into the positioning hole 35d formed in the mask plate 35.

The LED elements 32, 33 and 34 are positioned on the plus electrode pad 37d of the base member 36 with comparatively rough accuracy (plus or minus about 20 μm), and are securely fixed by silver paste. Owing to this, the electrode pads (not shown) provided on the lower faces of the LED elements 32, 33 and 34 are electrically connected to the plus electrode pad 37d. When the LED elements 32, 33 and 34 are located, they are arranged such that corner portions of the LED elements 32, 33 and 34 are respectively positioned under the beam openings 35a, 35b and 35c formed in the mask plate 35.

Then, the electrode pads 32a, 33a and 34a provided on the central upper faces of the LED elements 32, 33 and 34 are respectively wired to the pads 37a, 37b and 37c so that the LED elements 32, 33 and 34 are electrically connected to the external terminals 38a, 38b, 38c and 38d via the pads 37a, 37b, 37c and 37d. Thus, each luminous level of the LED elements 32, 33 and 34 may be controlled in accordance with a value of a current inputted from the external terminal.

After attaching the LED elements 32, 33 and 34 to the base member 36, transparent epoxy is poured into the LED-element containing portion 36a for molding. After molding, the protrusion 39 is inserted into the hole 35d for positioning. Successively, the base member 36 on which the LED elements 32, 33 and 34 are arranged is adhered and fixed to the mask plate 35.

An operation of the above structure is described below. In accordance with image data for exposing, a current flows from a controller to the external terminals 38a, 38b, 38c and 38d provided on the LED beam source 11 so that each of the LED elements 32, 33 and 34 emits the light. The luminous level of each LED element is determined by a value of the current. Three kinds of the emitted beams pass through the beam openings 35a, 35b and 35c respectively corresponding thereto to be radiated toward the outside of the LED beam source 11.

The LED beams having been radiated to the outside have a shape and an interval which are identical with those of the beam openings 35a, 35b and 35c. In other words, the radiated LED beam has a square shape of 100 μm, and the interval of the LED beams is 500 μm. At this time, the beam does not escape from any portion except the beam openings 35a, 35b and 35c, since the LED elements 32, 33 and 34 are covered with the mask plate 35 and the base member 36.

As shown in FIG. 1, the LED beam emitted from the LED beam source 11 is reflected by the mirror 12 and is converted to the parallel beam by means of the collimator lens 13. The beam from the collimator lens 13 is reflected by the polygon mirror 14 and passes through the f·θ lens 16. After that, an optical path of the beam is turned by the exposure mirror 19 to expose the instant film unit 17.

In the present embodiment, magnification of the optical system is set to an actual size so that, such as shown in FIGS. 5A and 5B, a shape and a size of beam spots 20a, 20b and 20c for exposing the instant film unit 17 are identical with the shape and the size of the beam openings 35a, 35b and 35c formed in the mask plate 35. In other words, the beam spot for exposure has a square shape of 100 μm.

The polygon mirror 14 is rotated at a constant speed so that a reflection angle of the beam changes to perform the exposure in the scanning direction. One scanning line is exposed whenever the polygon mirror 14 is rotated by one sixth. Meanwhile, the controller for letting the current flow in the LED beam source 11 changes the current value in accordance with the rotational speed of the polygon mirror 14. When the polygon mirror 14 is rotated by one sixth, the spreading roller 18 moves the instant film unit 17 by 100 μm in the sub-scanning direction to expose the next scanning line.

The interval of the beam openings 35a, 35b and 35c is five times of the size thereof. Thus, as shown in FIG. 6, pixel density maps 41a, 41b and 41c of red, blue and green are shifted by five pixels in the scanning direction. The image data are read every scanning line in synchronism with the rotation of the polygon mirror 14. The instant film unit 17 is normally exposed by controlling the respective LED elements 32, 33 and 34.

By the way, the scanning beam spot may be shifted in a perpendicular direction to the scanning line, namely in an advancing direction of the photo film, to form three scanning lines of red, blue and green in parallel. In this case, the scanning lines may be overlapped owing to advancement of the exposure surface. Meanwhile, regarding an analog signal of each scanning line formed from pixel map data of each color, an individual delay time may be set. In other words, it may be considered to use a complicated method, every exposure device, in which a delay time within a distance level up to one pixel may be set relative to the scanning lines of two colors so as to be adjusted to the residual scanning line.

Such as described above, the stray light is obstructed by the mask plate 35, and the accurate beam spot is obtained by means of the beam openings 35a, 35b and 35c formed in the mask plate 35. Moreover, the positioning protrusion 39 provided on the base member 36 is inserted into the positioning hole 35d formed in the mask plate 35. In virtue of this, the LED elements 32, 33 and 34 are allowed to be arranged with comparatively rough precision so that attachment thereof may be easily performed without deteriorating the accuracy.

The electrode pads 32a, 33a and 34a for wiring the LED elements 32, 33 and 34 are located so as not to be positioned under the beam openings 35a, 35b and 35c formed in the mask plate 35. In virtue of this, normal exposure is performed without interference. Incidentally, in the above-described embodiment, is used the mask plate 35 which is independent of the base member 36. The mask plate, however, may be unified with the base member 36. In this case, the mask plate made of a thin metal film or the like is formed after mounting the chips.

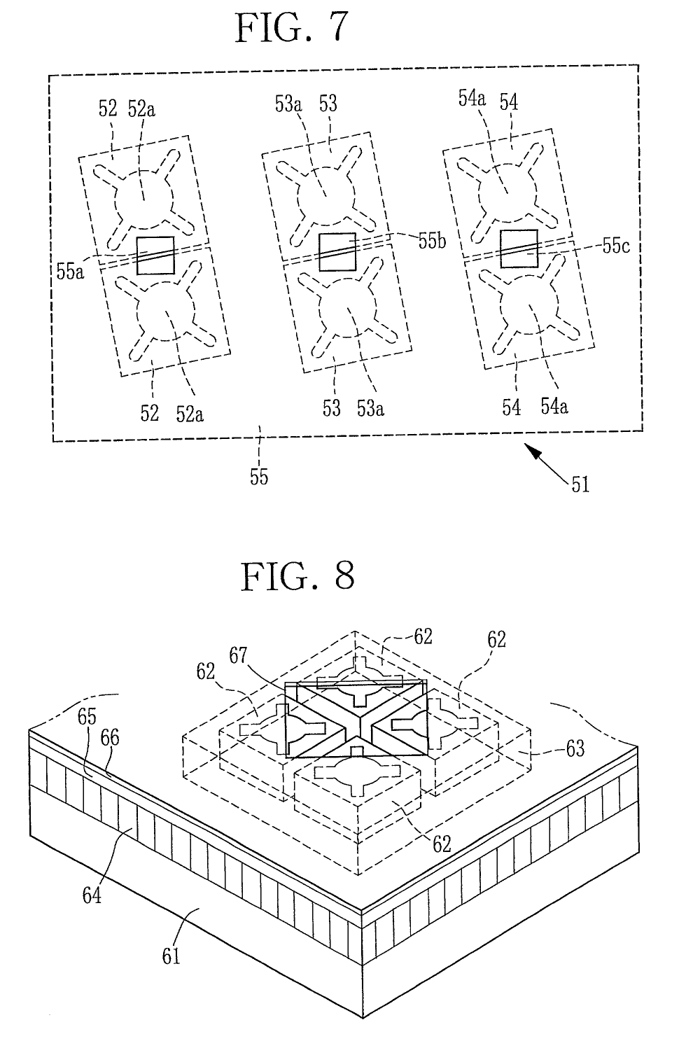

The LED elements used for the light source are not exclusive to a single red light, a single blue light and a single green light. Such as shown in FIG. 7, an LED beam source 51 may include two LED chips 52 for emitting the red light, two LED chips 53 for emitting the blue light, and two LED chips 54 for emitting the green light. The respective two chips are fixed on a base member and are disposed in an adjacent state. Central portions of the respective LED chips 52, 53 and 54 are occupied by electrode pads 52a, 53a and 54a made of a thin metal film. The central portion is a non-light-emitting region.

In this modified embodiment, similarly to the foregoing embodiment, a mask plate 55 superimposed on a ceramic base member is formed with beam openings 55a, 55b, 55c having a square shape of 100 μm. These openings 55a, 55b, 55c are formed at intervals of 500 μm and are respectively positioned at the middle of the two LED chips. Thus, the beam opening 55a strides over the light-emitting regions of the LED chips 52 to secure the light spot of red. Similarly, the beam openings 55b and 55c stride over the light-emitting regions of the LED chips 53 and 54 respectively to secure the light spots of blue and green.

Incidentally, the LED chips 52, 53 and 54 are disposed so as to be slightly inclined relative to an arrangement direction of the beam openings 55a, 55b and 55c. Owing to this, gaps of the respective two LED chips are adapted so as not to form the scanning line.

Even if a large non-light-emitting area of the electrode pad exists at the center of the LED chip such as shown in FIG. 3, it is possible to obtain a light spot having a necessary size in virtue of overlapping with the plural LED chips. Thus, a dark portion caused by the electrode pad is not formed in the beam spot on the exposure surface.

Moreover, even if an amount of the light emitted from the electrode pad toward the periphery thereof is reduced on the light emitting face of the LED chip, it is possible to equalize brightness of upper and lower edges of the light spot by positioning the beam opening in the state of overlapping with the two LED chips. Thus, a uniform light beam is obtained.

In FIG. 8, four LED chips 62 for emitting the red light are disposed on a thick base member 61 made of copper. The LED chips 62 are positioned in matrix and are fixed by silver paste. On the base member 61, is also fixed a spacer 64 made of a glass material. The spacer 64 is provided with a run-off opening 63 through which the four LED chips 62 pass. A surface of the spacer 64 is formed with a wiring pattern for wiring an electrode pad of a light emitting face of the LED chip 62.

An insulating protect layer 65 made of a transparent material is formed so as to cover the whole face of the LED chips 62 and the spacer 64. After that, an aluminum thin film 66 formed in sputtering is superimposed on the insulating protect layer 65. Then, photo resist is applied on the aluminum thin film 66 to carry out photo etching in which mask exposure is performed relative to only an opening 67. In this way, the aluminum thin film 66 corresponding to the opening 67 is removed. Also as to LEDs for emitting the blue light and the green light, the respective openings 67 are simultaneously formed in the aluminum thin film 66.

According to the light source of this modified embodiment, a large light spot having a square shape of 300 μm or 400 μm can be formed by using an LED chip having a square shape of 250 μm, for example. In the embodiment shown in FIGS. 1 through 6, an optical projection system of an actual size is adopted so that a light spot having a square shape of 100 μm is used for forming a scanning beam spot having a square shape of 100 μm.

However, when a reduction optical system of 2 to 1 is adopted in order to obtain the scanning beam spot having high exposure density, it is necessary to prepare the light spot having a square shape of 200 μm for forming the scanning beam spot having a square shape of 100 μm on the exposure surface.

Also in such a case, by arranging a plurality of the LED chips and by combining the mask member formed with the opening which overlaps with the plural light-emitting regions, the LED chip of the existent size may be effectively employed. Hence, the light source having stable quality and high reliability may be surely manufactured at low cost.

Since the thick copper plate is adopted as the base, fever due to the LED chips 62 densely disposed is effectively eliminated. Thus, the light spot is kept without causing thermal breaking.

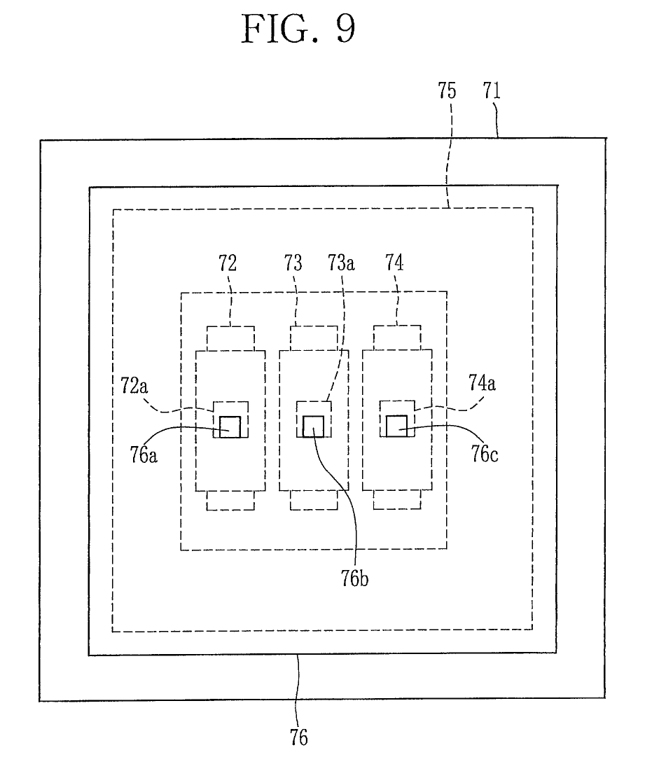

In FIG. 9, packaged LED elements 72, 73 and 74, a number of which is three, are fixed side by side on a glass plate 71 on which a wiring pattern is formed. The packaged LED elements 72, 73 and 74 are versatile parts completed as individual elements which include LED elements 72a, 73a and 74a respectively contained in epoxy molds having a width of 1 mm and a length of 4 mm. The LED elements 72a, 73a and 74a emit the light of red, blue and green respectively, and terminal electrodes for wiring are brought out therefrom.

A spacer 75 of which thickness is identical with that of the packaged LED elements 72, 73 and 74 is fixed on the glass plate 71 so as to surround the packaged LED elements 72, 73 and 74. A mask plate 76 is superimposed on the spacer 75 to be fixed. The mask plate 76 is provided with openings 76a, 76b and 76c for emitting three light spots of the LED elements 72a, 73a and 74a.

According to the light source of this modified embodiment, the light source may be easily attached by employing the versatile packaged LED elements. Meanwhile, such a packaged LED element sometimes includes a small amount of diffused-reflection minute particle in an epoxy mold resin. In this case, a luminous-flux amount of the light spot is reduced by a little. However, the light due to diffused reflection is obtained from an above portion of the electrode pad of the LED chip so that it is not necessary to forcibly position the openings 76a, 76b and 76c at corners of the LED elements 72a, 73a and 74a.

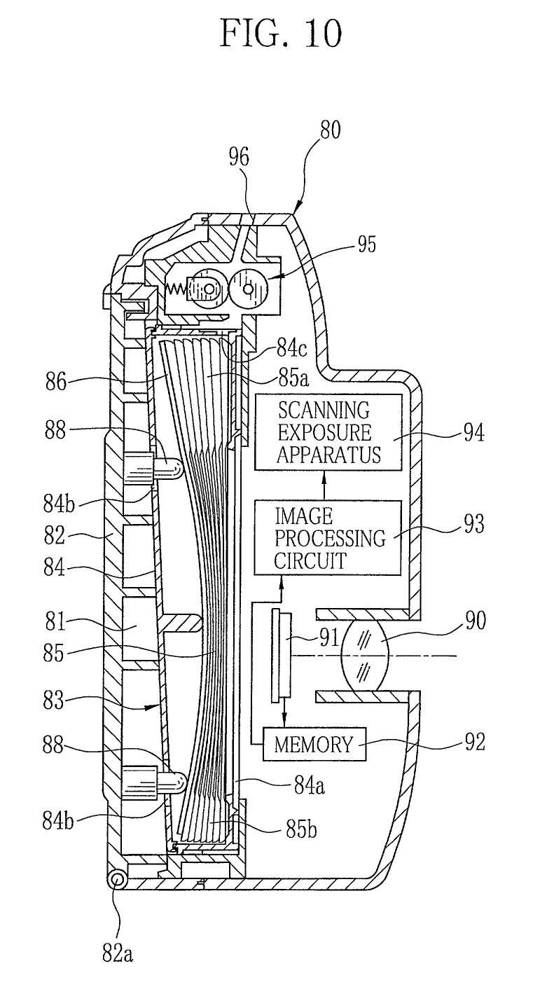

FIG. 10 shows an electronic still camera including a printer in which the present invention is built. The back of the camera 80 is formed with a pack chamber 81. After opening a lid 82 around a hinge 82a, the pack chamber 81 is loaded with an instant film pack 83. This instant film pack 83 is constituted of a box-shaped case 84, an instant film unit 85, and a support plate 86 having flexibility. A number of the instant film units 85 contained in the case 84 is about ten.

The front of the case 84 is formed with a large exposure aperture 84a having a square shape. Moreover, the bottom of the case 84 is formed with a plurality of holes 84b. The side of the case 84 is formed with an outlet 84c for discharging the exposed instant film unit 85 toward the outside thereof.

The inside of the lid 82 is provided with a plurality of projections 88 urged by a spring (not shown). When the lid 82 is closed, the respective projections 88 enter the holes 84b to press the instant film unit 85 toward the exposure aperture 84a via the support plate 86. Meanwhile, as well known, the instant film unit 85 includes a developer pod 85a, a redundant-developer trap 85b, and an image recording region provided between them.

A taking lens 90 is disposed at the front of the camera 80 to form an image of a photographic scene on an image area sensor 91. When a picture button (not shown) is pressed, three-color image signals read from the image area sensor 91 are stored in a memory 92. The camera 80 has a photographic mode for merely photographing, a mode for photographing and simultaneously printing, and a print mode for merely printing.

Upon instruction of printing, the three-color image signals read from the memory 92 are processed in an image processing circuit 93 to be sent to a scanning exposure apparatus 94. This scanning exposure apparatus 94 has a structure such as shown in FIG. 1. In accordance with the three-color image signals, light intensity of respective LEDs of red, blue and green are controlled.

The uppermost instant film unit 85 in the case 84 is pushed out by a claw (not shown). This instant film unit 85 passes through the outlet 84c, and the top thereof is nipped by a spreading roller pair 95. This spreading roller pair 95 is rotated in association with the claw to convey the instant film unit 85 toward a camera outlet 96 in a pressing state. In synchronism with the conveyance of the instant film unit 85, the scanning exposure apparatus 94 is actuated to record an image on the image recording region of the instant film unit 85 one line by one line.

Just after the conveyance of the instant film unit 85, the developer pod 85a is crushed by the spreading roller pair 95. Developer flowing from the pod 85a is spread on the instant film unit 85 with the roller pair 95 in a uniform thickness to develop the recorded region.

In this way, the instant film unit 85 is exposed in line at the time of passing the scanning exposure apparatus 94, and then, the developer is spread by the spreading roller pair 95. The instant film unit 85 is manually drawn out of the camera 80 after the end of the instant film unit 85 has passed through the spreading roller pair 95. As to this instant film unit 85, a positive image gradually appears on the image recording region in accordance with progress of the development.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. An LED beam source for radiating a plurality of light beams, scanning of said beams being performed by scanning mirror means for recording an image, said LED beam source comprising:
a plurality of LED elements for emitting light, said LED element having light-emitting timing and light intensity which are independently controllable; and
a mask member for commonly covering light emitting faces of said LED elements, said mask member being provided with openings every beams in order to form said beams from said light.

2. An LED beam source according to claim 1, wherein a size of said opening is determined such that a size of a beam spot formed on an exposure surface is divided by a magnification of an optical system disposed between said opening and said exposure surface.

3. An LED beam source according to claim 1, wherein a distance of the neighboring openings is substantially natural-number times as long as said size of said opening.

4. An LED beam source according to claim 1, wherein a number of said LED elements is three respectively outputting red light, blue light and green light, intensity of which is respectively controlled in accordance with image data of red, blue and green, and said mask member is formed with three openings having a same shape and a same area so as to correspond to the respective LED elements.

5. An LED beam source according to claim 1, wherein said LED element includes an electrode pad for wiring on said light emitting face thereof, and said opening of said mask member is disposed above said light emitting face so as not to overlap with said electrode pad.

6. An LED beam source according to claim 1, wherein said plural LED elements are fixed to a common base member and comprise three kinds of LED chips corresponding to three primary colors, and said mask member is fixed to said base member so as to position said openings at light-emitting regions of said LED chips.

7. An LED beam source according to claim 6, further comprising:
positioning means for retaining both of said base member and said mask member with each other, said positioning means mechanically setting a positional relationship between said light emitting face of said LED element and said opening of said mask member.

8. An LED beam source according to claim 7, wherein said positioning means includes:
at least one protrusion provided on said base member; and
at least one positioning hole formed in said mask member and for fitting to said protrusion.

9. An LED beam source according to claim 8, wherein said protrusions are provided at four corners of said base member, and said positioning holes are formed at four corners of said mask member.

10. An LED beam source according to claim 9, wherein said protrusion and said positioning hole have a circular shape.

11. An LED beam source according to claim 1, wherein said plural LED elements are fixed to a common base member and comprise three kinds of LED chips corresponding to three primary colors, said LED chips of at least one kind being two or more which are adjacently arranged on said base member, and said opening of said mask member is disposed so as to form said beam with said plural LED chips.

12. An LED beam source according to claim 11, wherein a number of said LED chips of at least one kind is two, and said opening is located between light emitting faces of said two LED chips.

13. An LED beam source according to claim 11, wherein a number of said LED chips of at least one kind is four.

14. An LED beam source according to claim 13, wherein said four LED chips are arranged in matrix, and said opening confronts four light emitting faces thereof.

15. An LED beam source according to claim 11, wherein said LED chips are slantingly disposed relative to an arrangement direction of said openings of said mask member to prevent a gap of said LED chips from forming a scanning line.

16. An LED beam source according to claims 6 or 11, wherein said LED elements are fixed to a concave formed on said base member.

17. A scanning exposure apparatus for scanning of light beams to expose a photosensitive material, said scanning exposure apparatus comprising:
an LED beam source for radiating said light beams;
wherein said LED beam source including:
a plurality of LED elements for emitting light, said LED element having light-emitting timing and light intensity which are independently controllable; and
a mask member for commonly covering light emitting faces of said LED elements, said mask member being provided with openings every beams in order to form said beams from said light.

18. A scanning exposure apparatus according to claim 17, further comprising:
first lens means for converting said beams from said LED beam source into parallel light;
scanning mirror means for scanning of said light beams, said scanning mirror means changing inclination of its reflection face; and
second lens means for making the light beam from said scanning mirror means converge to form a plurality of beam spots on an exposure surface of said photosensitive material.

19. A scanning exposure apparatus according to claim 18, wherein said first lens means is a collimator lens, said scanning mirror means is a polygon mirror, and said second lens means is an f·θ lens.

20. A scanning exposure apparatus according to claim 19, further comprises:
an exposure mirror for reflecting the light from said second lens means toward said photosensitive material.
